(19) United States
(12) Patent Application Publication
(10) Pub. No.: US 2025/0135863 A1
(43) Pub. Date: May 1, 2025

(54) BODY FOR ELECTRIC VEHICLE

(71) Applicants: Hyundai Motor Company, Seoul (KR); Kia Corporation, Seoul (KR)

(72) Inventors: Gyung Hoon Shin, Seoul (KR); Chan Sol Kim, Seoul (KR); Jong Gyu Park, Hwaseong-si (KR)

(21) Appl. No.: 18/609,253

(22) Filed: Mar. 19, 2024

(30) Foreign Application Priority Data
Oct. 31, 2023 (KR) 10-2023-0148288

(51) Int. Cl. B60K 1/04; B60L 50/64; H01M 50/209; H01M 50/249; H01M 50/271

(52) U.S. Cl. CPC B60K 1/04; B60L 50/64; H01M 50/209; H01M 50/249; H01M 50/271; B60K 2001/0438; B60K 2001/0455; H01M 2220/20

(57) ABSTRACT

An electric vehicle body can be configured to minimize the entry of foreign matters in a replaceable battery pack region while facilitating battery pack replacement. An electric vehicle body can include first and second battery packs replaceably mounted on a chassis frame, a cover bracket extending on one side of the first battery pack, and an undercover extending on one side of the second battery pack adjacent to the first battery pack and overlapping the cover bracket to seal off a gap between the first battery pack and the second battery pack.

### CROSS-REFERENCE TO RELATED APPLICATIONS

This application claims the benefit of Korean Patent Application No. 10-2023-0148288, filed on Oct. 31, 2023, which application is hereby incorporated herein by reference.

### TECHNICAL FIELD

The present disclosure relates to an electric vehicle body.

### BACKGROUND

Conventional electric vehicles have a structure that makes it difficult to mount and remove the battery system, which leads to a problem of inefficiency in terms of fuel economy for consumers who drive both short and long distances.

For example, because vehicles primarily driven for short-distance trips carry sizable and heavy batteries mounted in the vehicles relative to the battery energy needed to operate the vehicles, the vehicles are put at a disadvantage in terms of fuel economy.

To address this issue, a structure may allow the mounting and removal of a plurality of batteries. However, foreign matters may enter the underbody of the vehicle while a battery is removed.

When an area is exposed under the vehicle in this manner, foreign matters may enter through the exposed area from the outside and get stuck between the batteries and the chassis frame or accumulate on the batteries.

Therefore, when replacing a battery at a battery replacement station, there is a concern about foreign matters either falling into the station or entering during the battery replacement process.

The matters described above as background technology are intended to provide a better understanding of the background of the present disclosure and should not be considered as acknowledging that the present disclosure and the background information provided herein pertain to the prior art as defined by the patent statute.

### SUMMARY

The present disclosure relates to an electric vehicle body configured to minimize the entry of foreign matters into a replaceable battery pack while facilitating battery pack replacement.

An embodiment of the present disclosure can resolve the issues described above by providing an electric vehicle body configured to minimize the entry of foreign matters into a replaceable battery pack while facilitating battery pack replacement.

An electric vehicle body according to an embodiment of the present disclosure includes at least one battery pack removably mounted on a chassis frame, a cover bracket extending on one side of the battery pack, and an undercover extending on one side of another battery pack adjacent to the battery pack and overlapping the cover bracket to seal off a gap formed between the battery pack and the other battery pack.

A hollow insertion tube may be formed on the cover bracket and an insertion protrusion may be formed on the undercover so that the insertion protrusion may be inserted into the insertion tube.

The insertion tube may protrude from the top surface of the cover bracket and the insertion protrusion may protrude from the top surface of the undercover so that the insertion protrusion may be inserted into the insertion tube as the undercover overlaps the lower portion of the cover bracket.

An inner protrusion may be formed on the inner surface of the insertion tube and an outer protrusion may be formed on the outer surface of the insertion protrusion so that the outer protrusion may catch on the upper end of the inner protrusion.

A transverse member of the chassis frame may be provided in the right-left direction, and the upper end of the insertion protrusion may be connected to the lower end of the transverse member.

A first connection hole may be formed at the lower end of the transverse member and a ring-shaped first elastic structure may be fixed to the inner surface of the connection hole so that the insertion protrusion may be inserted into the first elastic structure to be connected thereto.

The width of the undercover may be equal to the width of the gap.

The bottom of the undercover may be positioned at the same height as or higher than the bottoms of the battery pack and the other battery pack.

The other battery pack for which the undercover is formed may be mounted in the rear of the battery pack for which the cover bracket is formed.

A battery mounting area for mounting a battery pack may be formed within the chassis frame, and when the battery mounting area is not occupied by a battery pack, an area cover may be provided in a shape sealing off the unoccupied battery mounting area.

The area cover may be removably mounted on the chassis frame.

The transverse member of the chassis frame may be provided in the right-left direction, a guide pin may protrude from the top surface of the area cover, and the guide pin may be connected to the transverse member to be attached thereto.

A second connection hole may be formed at the lower end of the transverse member and a ring-shaped second elastic structure may be fixed to the inner surface of the second connection hole so that the guide pin may be inserted into the second elastic structure to be attached thereto.

A dummy connector may be provided on the top surface of the area cover so that a vehicle connector may be connected thereto.

Another electric vehicle body according to the present disclosure may include at least one battery pack replaceably mounted on a chassis frame, a first undercover extending on one side of the battery pack, and a second undercover extending on one side of another battery pack adjacent to the battery pack and overlapping the first undercover to seal off a gap formed between the battery pack and the other battery pack together with the first undercover.

The first undercover and the second undercover may overlap each other in a sloping structure.

A first slope may be formed on the underside of the first undercover and a second slope matching the first slope may be formed on the top surface of the second undercover to overlap the first slope.

The other battery pack for which the second undercover is formed may be mounted in the rear of the battery pack for which the first undercover is formed.

The width of overlap between the first undercover and the second undercover may be equal to the width of the gap.

The bottoms of the first undercover and the second undercover may be positioned at the same height as or higher than the bottom surface of the battery pack and the other battery pack.

An embodiment of the present disclosure can provide undercovers for replaceable battery packs such that the gap formed between the front and rear battery packs is automatically sealed off by extending covers during battery pack replacement.

Therefore, not only is the gap easily sealed off, but foreign matters can be prevented or hindered from getting caught or accumulating between the batteries and chassis frame, thereby having the effect of preventing or hindering the entry of foreign matters during battery replacement and while a battery is omitted.

### BRIEF DESCRIPTION OF THE DRAWINGS

The above and other features and advantages of the present disclosure can be more apparent from the following detailed description taken in conjunction with the accompanying drawings, in which:

FIG. 1 is an exploded perspective view for describing a structure for mounting and removing a plurality of batteries for replacement according to an embodiment of the present disclosure;

FIG. 2 is a perspective view illustrating a state in which a replaceable battery pack is mounted on a chassis frame of a vehicle according to an embodiment of the present disclosure;

FIG. 3 is a cross-section view taken along line A-A in FIG. 2 to illustrate a first embodiment configuration in which a gap formed between batteries is sealed off by an undercover according to an embodiment of the present disclosure;

FIG. 4 is a zoomed-in view illustrating the undercover in FIG. 3, as viewed from above;

FIG. 5 is a view illustrating the undercover in FIG. 3, as viewed from below;

FIG. 6 is a view illustrating a second embodiment configuration in which a gap formed between batteries is sealed off by an undercover according to an embodiment of the present disclosure;

FIG. 7 is a zoomed-in view illustrating the undercover in FIG. 6, as viewed from above;

FIG. 8 is a perspective view illustrating a configuration in which an unoccupied battery area is sealed off by an area cover according to an embodiment of the present disclosure;

FIG. 9 is a view illustrating an area cover according to an embodiment of the present disclosure;

FIG. 10 is a cross-section view of the portion “B” in FIG. 8, illustrating a structure in which an area cover is connected to a transverse member according to an embodiment of the present disclosure; and

FIG. 11 is a cross-section view illustrating a third embodiment configuration in which a gap formed between batteries is sealed off by the first and second undercovers according to an embodiment of the present disclosure.

### DETAILED DESCRIPTION OF ILLUSTRATIVE EMBODIMENTS

Embodiments disclosed in the present specification will be described in detail with reference to the accompanying drawings, and same reference numerals can be assigned to similar or same components regardless of drawing numbers, and repetitive descriptions can be omitted.

The suffixes “module” and “unit” for the components used in the following description can be given or interchangeably used to facilitate the writing of the specification, without necessarily indicating a distinct meaning or role of their own.

When it is determined that the specific description of the related and already known technology may obscure the essence of the embodiments disclosed herein, such specific description may be omitted. Further, it is to be understood that the accompanying drawings are intended to facilitate understanding of the embodiments disclosed herein and are not intended to necessarily limit the technical ideas disclosed herein, which are not necessarily limited to the accompanying drawings and include all the modifications, equivalents, or substitutions within the spirit and technical scope of the present disclosure.

Terms including ordinal numbers such as “first,” “second,” and the like, may be used to describe various components, but the components are not necessarily limited by such terms. Such terms may be used merely for the purpose of distinguishing one component from another.

It is to be understood that when a component is referred to as being “connected” or “coupled” to another component, the component may be directly connected or coupled to the other component, and other components may be interposed therebetween. In contrast, it is to be understood that when a component is referred to as being “directly connected” or “directly coupled” to another component, no other component is interposed.

Singular expressions can include plural expressions unless the context explicitly indicates otherwise.

In the present specification, terms such as “comprise” or “have” are intended to indicate the presence of implemented features, numbers, steps, manipulations, components, parts, or combinations thereof, described in the specification and are not to be understood to preclude the presence or additional possibilities of one or more of other features, numbers, steps, manipulations, components, parts, or combinations thereof.

In a vehicle that can accommodate three batteries, fuel efficiency can be improved by mounting only one battery for short-distance driving and all three batteries for long-distance driving. However, such a replaceable battery system can have a problem that foreign matters may enter the underbody of the vehicle or the batteries may be damaged by an underbody collision. For example, when only one or two out of the three batteries are mounted, the area where no battery is mounted can be exposed under the vehicle. Even when all three batteries are mounted, gaps can emerge between the batteries, resulting in exposed areas under the vehicle. When an area is exposed under the vehicle in this manner, foreign matters can enter through the exposed area from the outside and get stuck between the batteries and the chassis frame or accumulate on the batteries. An embodiment of the present disclosure can address these issues and problems.

Embodiments of the present disclosure will be described in detail with reference to the accompanying diagrams below.

An electric vehicle body according to an embodiment of the present disclosure includes at least one battery pack 100 replaceably mounted on a chassis frame 800, a cover bracket 200 extending on one side of the battery pack 100, and an undercover 300 extending on one side of another battery pack 100 adjacent to the battery pack 100 and overlapping the cover bracket 200 to seal off a gap (g) formed between the battery pack 100 and the other battery pack 100.

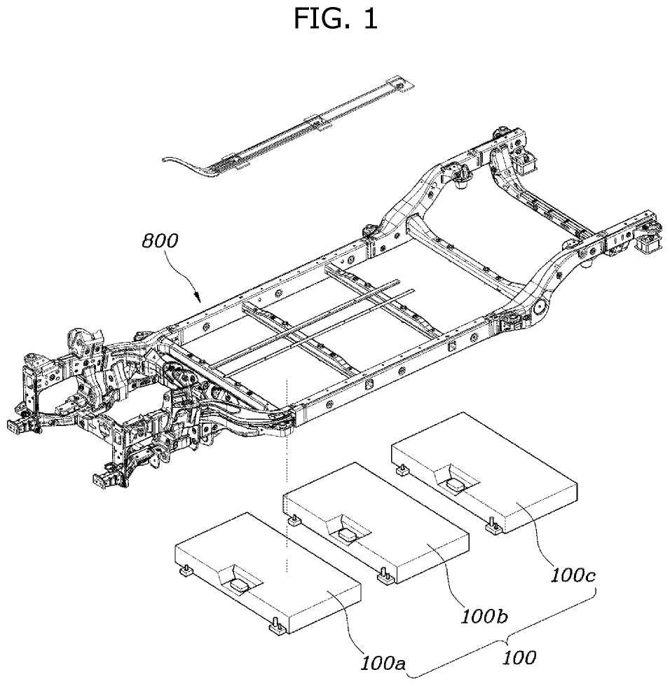

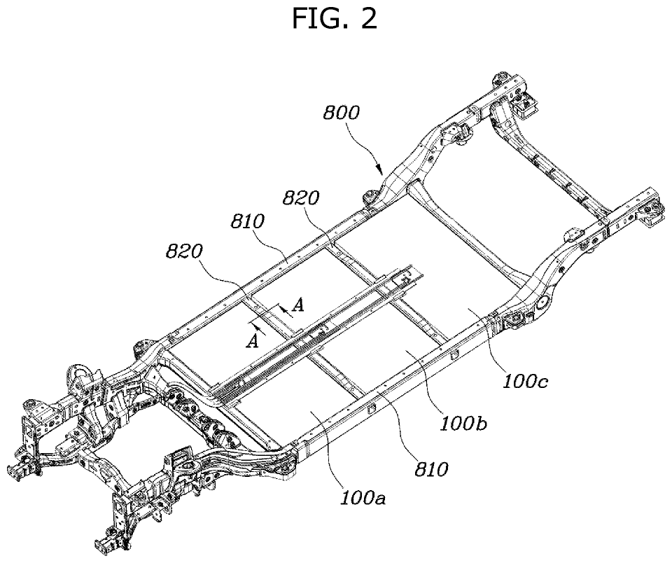

FIGS. 1 to 3 show that the battery pack 100 can include battery modules with a stack of a plurality of cells inside located on the right and left sides and an electrical equipment unit for managing power and sensing of the batteries, along with busbars connecting power between the battery modules.

An electrical unit, along with the battery module, can be supported through a lower case 120 at the lower end of the battery pack 100 while the upper end of the battery pack 100 can be covered by an upper case 110.

A member-shaped side surface member 130 can be fixed to the top surface of the lower case 120 and the upper case 110 can be fixed to the upper end of the side surface member 130, sealing off the front, rear, left, and right ends of the battery pack 100 so that the battery pack 100 having a sealed structure can be secured.

Such a battery pack 100 can be mounted and removed on the chassis frame 800 that forms a vehicle body.

Side members 810 can be provided on the right and left sides of the vehicle body, and transverse members 820 can be connected between the right and left side members 810.

The transverse members 820 can be located at selected or predetermined intervals in the length direction of the side members 810 and the battery pack 100 can be removably coupled to a rectangular battery mounting area (a) formed between the right and left side members 810 and the front and rear transverse members 820 so that the battery pack 100 may be replaced.

Specifically, a pin-shaped fastening portion can protrude upward from the side surface members 130 positioned at the front and rear ends of the battery pack 100.

A groove-shaped fastening groove portion can be formed at a position on the underside of the transverse member 820, facing the mounting portion so that the battery pack 100 may be mounted and removed on the transverse member 820.

At least one battery mounting area (a) can be formed in the front-rear direction of the vehicle, with each battery mounting area (a) accommodating a battery pack 100.

However, even when battery packs 100 are mounted in all battery mounting areas (a), a gap (g) can be formed between the battery packs 100a, 100b, allowing the potential entry of foreign matters from outside through the gap (g).

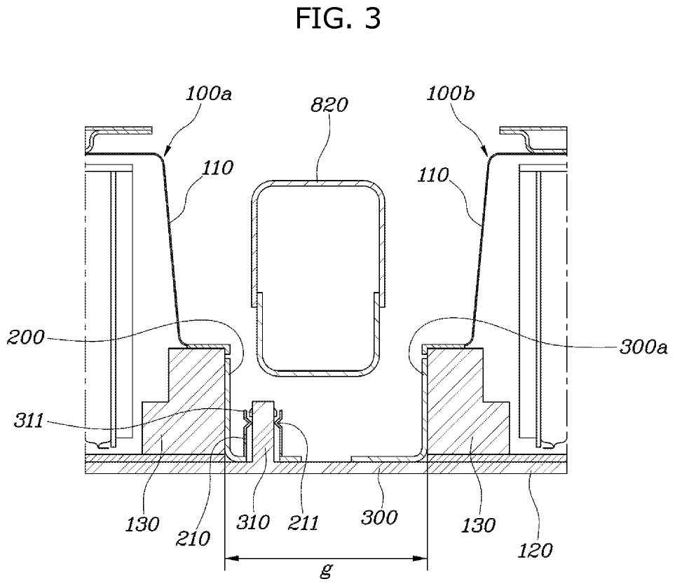

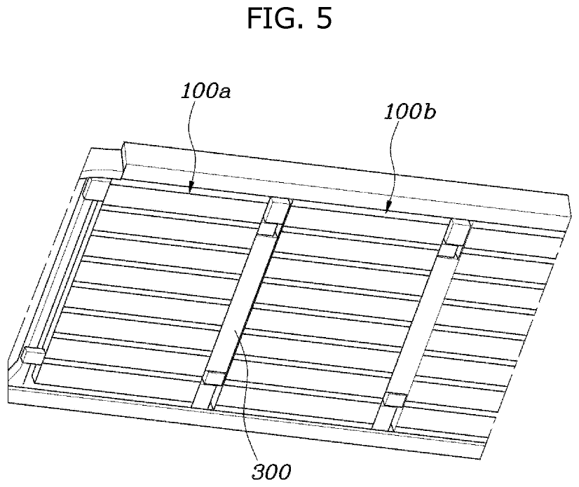

To prevent the entry of foreign matters, as illustrated in FIGS. 3 to 5, the cover bracket 200 can be fixed to the rear end side surface member 130 formed in the front battery pack 100a, facing the rear battery pack 100b. The cover bracket 200, configured in an ‘L’ shape, can include a vertical portion fixed to the side surface member 130 in the vertical direction and a horizontal portion can be extending toward the rear battery pack 100b in the horizontal direction.

A connection bracket 300a can be fixed to the front end side surface member 130 formed in the rear battery pack 100b, facing the front battery pack 100a. The connection bracket 300a, configured in an ‘L’ shape, can feature a vertical portion fixed to the side surface member 130 in the vertical direction and a horizontal portion extending toward the front battery pack 100a in the horizontal direction.

In particular, the top surface of the undercover 300 can be formed in a plate shape and can be fixed to the underside of the horizontal portion of the connection bracket 300a.

The undercover 300 can be formed to face the front battery pack 100a, overlapping the underside of the cover bracket 200 fixed to the front battery pack 100a.

Thus, the gap (g) formed between the front battery pack 100a and the rear battery pack 100b can be automatically sealed off by the undercover 300 during battery pack mounting.

Therefore, not only is the gap (g) easily sealed off but also foreign matters can be prevented or hindered from getting stuck or accumulating between the batteries and the chassis frame 800 so that the entry of foreign matters can be prevented or hindered during battery replacement.

Furthermore, according to an embodiment of the present disclosure, a hollow insertion tube 210 can be formed on the cover bracket 200 and an insertion protrusion 310 can be formed on the undercover 300 so that the insertion protrusion 310 may be inserted into the insertion tube 210.

The insertion tube 210 can protrude from the top surface of the cover bracket 200 and the insertion protrusion 310 can protrude from the top surface of the undercover 300 so that the insertion protrusion 310 may be inserted into the insertion tube 210 as the undercover 300 overlaps the lower portion of the cover bracket 200.

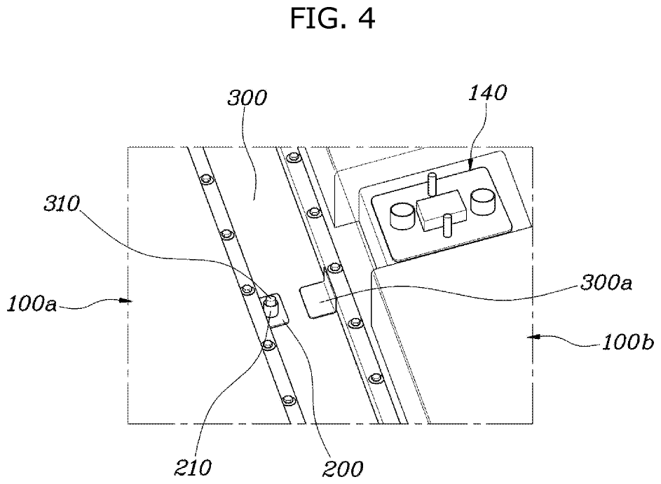

FIGS. 3 and 4 show that the insertion tube 210 can protrude upward from the top surface of the horizontal portion of the cover bracket 200 vertically.

The insertion tube 210 can be open at the upper and lower ends, forming a hollow space.

Furthermore, the insertion protrusion 310 can protrude upward vertically from the top surface of the horizontal portion of the connection bracket 300a at the position where the insertion protrusion 310 faces the insertion tube 210.

The outer diameter of the insertion protrusion 310 can be equal to or is slightly less than the inner diameter of the insertion tube 210 so that the insertion protrusion 310 can be inserted into the insertion tube 210 to be coupled thereto.

In other words, the insertion protrusion 310 can be inserted upward at the lower portion of the insertion tube 210 to be assembled in the insertion tube 210.

Furthermore, an inner protrusion 211 can be formed on the inner surface of the insertion tube 210, and an outer protrusion 311 can be formed on the outer surface of the insertion protrusion 310 so that the outer protrusion 311 may catch on the upper end of the inner protrusion 211.

For example, the inner protrusion 211 in the shape of step molding can be formed along the circumference of the inner circumferential surface of the insertion tube 210, and the outer protrusion 311 in the shape of step molding can be formed along the circumference of the outer circumferential surface of the insertion protrusion 310.

The insertion tube 210 may be made of a material with a selected or predetermined level of elasticity or higher.

Thus, as the insertion protrusion 310 is inserted into the insertion tube 210 and moves upward, the inner protrusion 211 can be pushed outward while the upper end of the outer protrusion 311 is in contact with the lower end of the inner protrusion 211.

Then, a portion of the inner protrusion 211 can expand outward radially by the elasticity of the insertion tube 210 so that the outer protrusion 311 moves upward over the inner projection 211, and then the radially expanded portion of the inner protrusion 211 can be retracted and the inner protrusion 211 is restored.

Therefore, the outer protrusion 311 can catch on the upper end of the inner protrusion 211 so that the insertion protrusion 310 can be prevented from detaching from the insertion tube 210, and thus the undercover 300 can be prevented from detaching, which can provide a snap-on or snap-in fit or fastener.

On the other hand, according to an embodiment of the present disclosure, the transverse member 820 of the chassis frame 800 may be provided in the right-left direction, and the upper end of the insertion protrusion 310 may be connected to the lower end of the transverse member 820.

Specifically, a first connection hole 830 can be formed at the lower end of the transverse member 820 and a ring-shaped first elastic structure 831 can be fixed to the inner surface of the connection hole so that the insertion protrusion 310 may be inserted into the first elastic structure 831 to be connected thereto.

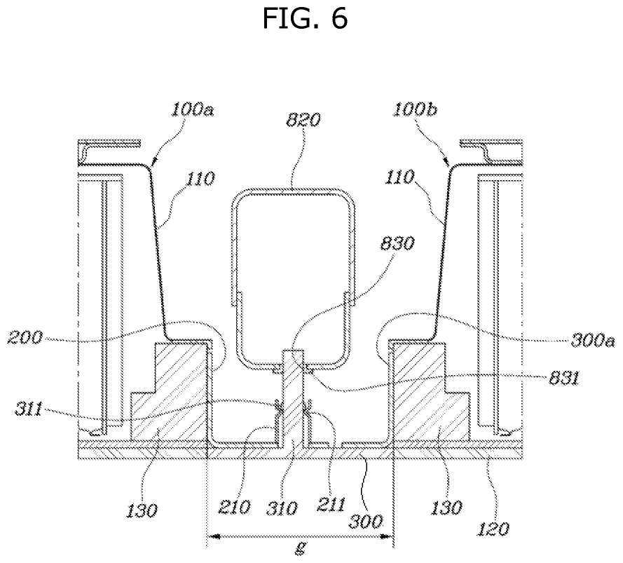

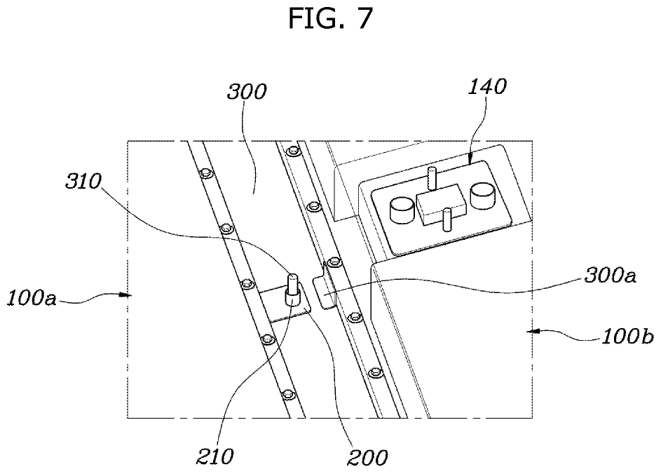

FIGS. 6 and 7 show that the first connection hole 830 can be formed at the lower end center of the transverse member 820 and the first elastic structure 831 can be made of a rubber material and can be inserted into the first connection hole 830 to compensate for friction noise and avoid interference from the components related to the undercover 300.

The insertion protrusion 310 can be positioned directly under the first connection hole 830, and the upper end of the insertion protrusion 310 can be elongated upward.

Thus, the upper end of the insertion protrusion 310 can be inserted through the first elastic structure 831 formed at the lower end of the transverse member 820 so that the insertion protrusion 310 can be connected to the transverse member 820.

Therefore, the insertion protrusion 310 can be formed on the undercover 300 and can be connected to the transverse member 820 so that additional connectivity of the undercover 300 can be ensured. As a result, the more robust binding and fixing force of the undercover 300 can be secured.

Furthermore, according to an embodiment of the present disclosure, the width of the undercover 300 can be equal to the width of the gap (g).

FIG. 3 shows that the front-to-rear length of the undercover 300 extending between the front battery pack 100a and the rear battery pack 100b can be equal to the front-to-rear length of the gap (g) formed between the front battery pack 100a and the rear battery pack 100b so that the gap (g) is tightly sealed off by the undercover 300 to prevent the entry of foreign matters more reliably.

Furthermore, according to an embodiment of the present disclosure, the bottom of the undercover 300 may be positioned at the same height as or higher than the bottoms of the battery pack 100 and the other battery pack 100.

FIG. 3 shows that when the battery pack 100 is at the lowest ground clearance of the vehicle, the bottom of the undercover 300 can be positioned at the same height as the bottom of the battery pack 100, or the bottom of the undercover 300 can be positioned higher than the bottom of the battery pack 100.

Positioning the undercover 300 lower than the battery pack 100 can further reduce the minimum ground clearance of the vehicle, and the marketability of the vehicle may be adversely affected consequently. Therefore, the position of the bottom of the undercover 300 relative to the position of the bottom of the battery pack 100 can be regulated.

Furthermore, according to an embodiment of the present disclosure, the battery pack 100 for which the undercover 300 is formed may be mounted in the rear of the battery pack 100 for which the cover bracket 200 is formed.

FIG. 3 shows that, in consideration of the replacement order of the battery pack 100, the undercover 300 can be fixed to the battery pack mounted in the rear among the two battery packs 100 mounted in the front and rear.

For example, because the rear battery pack 100b can be removed when one of the two battery packs 100a, 100b mounted in the front and rear is to be removed, configuring the rear battery pack 100b, to be removed first, with the undercover 300 can allow the downward removal of the undercover 300 and further can allow the downward detachment of the insertion protrusion 310 formed on the undercover 300 from the insertion tube 210. As a result, the replacement of the battery pack 100 can be smoothly carried out.

On the other hand, according to an embodiment of the present disclosure, a battery mounting area (a) for mounting the battery pack 100 can be formed within the chassis frame 800, and when the battery mounting area (a) is not occupied by the battery pack 100, an area cover 600 may be provided in a shape sealing off the unoccupied battery mounting area (a).

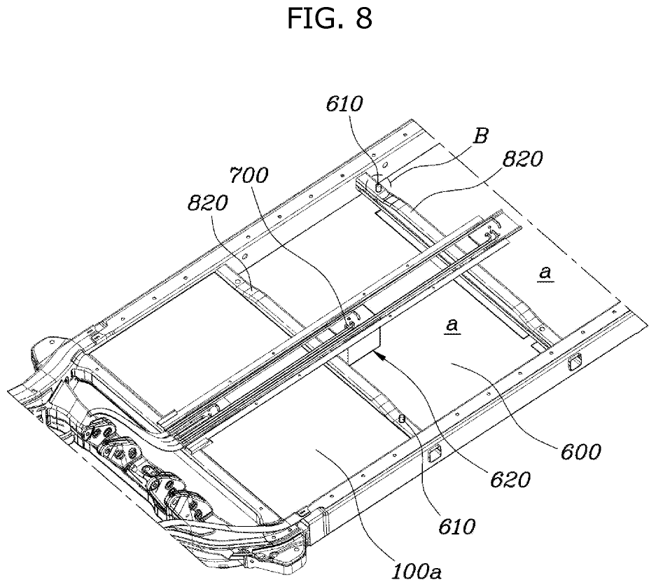

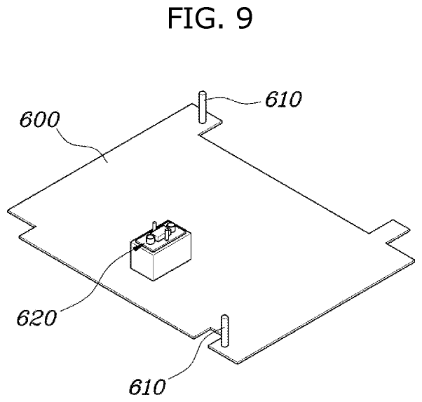

FIGS. 8 and 9 show that when three battery mounting areas (a) are formed in the vehicle and only one battery pack is to be mounted in the forwardmost area among the three battery mounting areas (a), the lower portions of the middle battery mounting area (a) and the rearward-most battery mounting area (a) can be exposed externally.

External exposure of the lower portions of the battery mounting areas (a) may cause foreign matters to enter a vehicle connector 700 connected to the vehicle, and connecting the battery pack 100 to the vehicle connector 700 in the presence of foreign matters may lead to malfunctions in the vehicle.

The vehicle connector 700 can be connected through wiring in the front-rear direction of the vehicle by wiring and is positioned above the battery connector 140 provided in the battery pack 100 to connect to the battery connector 140. As a result, it can be possible to supply both high and low voltage from the battery pack 100 to the vehicle.

Thus, the exposed area can be sealed off through the area cover 600 by coupling the area cover 600 formed in a plate shape to the lower portion of the battery mounting area (a) in which the battery pack 100 is not mounted.

Therefore, entry of foreign matters in the vehicle connector 700 can be prevented so that the risk of malfunction in the vehicle can be prevented.

Furthermore, according to an embodiment of the present disclosure, the area cover 600 may be removably mounted on the chassis frame 800.

The transverse member 820 of the chassis frame 800 can be provided in the right-left direction, a guide pin 610 can protrude from the top surface of the area cover 600, and the guide pin 610 may be connected to the transverse member 820 to be attached thereto.

Specifically, a second connection hole 840 can be formed at the lower end of the transverse member 820 and a ring-shaped second elastic structure 841 can be fixed to the inner surface of the second connection hole 840 so that the guide pin 610 may be inserted into the second elastic structure 841 to be attached thereto.

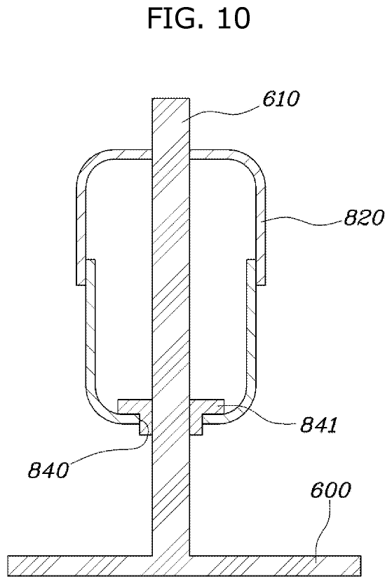

FIGS. 8 and 10 show that a second connection hole 840 can be formed at the lower end center of the transverse member 820, and a second elastic structure 841 made of a rubber material can be inserted into the second connection hole 840.

The guide pin 610 can be positioned directly under the second connection hole 840 and the upper end of the guide pin 610 can be elongated upward.

Thus, the upper end of the guide pin 610 can be inserted through the second elastic structure 841 formed at the lower end of the transverse member 820 so that the guide pin 610 may be attached to the transverse member 820.

An additional second connection hole 840 may be formed at the upper end of the transverse member 820 and the guide pin 610 may be further elongated upward so that the guide pin 610 may be coupled through the upper end of the transverse member 820.

Therefore, the binding and fixing force of the area cover 600 can be secured by coupling the guide pin 610 formed on the area cover 600 to the transverse member 820.

Furthermore, according to an embodiment of the present disclosure, a dummy connector 620 may be provided on the top surface of the area cover 600 for the vehicle connector 700 to be connected thereto.

FIGS. 8 and 9 show that a frame can be connected at the position where the dummy connector faces the vehicle connector 700 on the top surface of the area cover 600, and the dummy connector 620 can be fixed to the frame.

Therefore, foreign matters can be fundamentally prevented or hindered from entering the vehicle connector 700 by connecting the dummy connector 620 to the vehicle connector 700 positioned in the battery mounting area (a) where the battery is not mounted.

On the other hand, according to an embodiment of the present disclosure, the first and second undercovers 400, 500 rather than the single undercover 300 may be used to seal off the gap (g).

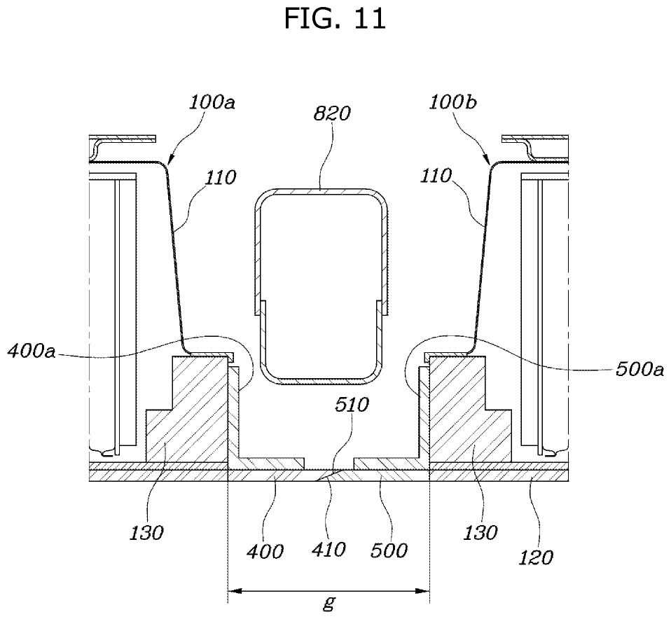

As illustrated in FIG. 11, in an embodiment of the present disclosure, at least one battery pack 100 can be replaceably mounted on the chassis frame 800, the first undercover 400 can extend on one side of the battery pack 100, and the second undercover 500 can extend on one side of another battery pack 100 adjacent to the battery pack 100 and overlapping the first undercover 400 to seal off the gap (g) formed between the battery pack 100 and the other battery pack 100 together with the first undercover 400 can be included.

FIG. 11 shows that the first connection bracket 400a can be fixed to the rear end side surface member 130 formed in the front battery pack 100a, facing the rear battery pack 100b. The first connection bracket 400a, configured in an ‘L’ shape, can include a vertical portion fixed to the side surface member 130 in the vertical direction and a horizontal portion extending toward the rear battery pack 100b in the horizontal direction.

The second connection bracket 500a can be fixed to the front end side surface member 130 formed in the rear battery pack 100b, facing the front battery pack 100a. The second connection bracket 500a, configured in an ‘L’ shape, can include a vertical portion fixed to the side surface member 130 in the vertical direction and a horizontal portion extending toward the front battery pack 100a in the horizontal direction.

In particular, the top surface of the first undercover 400 can be formed in a plate shape is fixed to the underside of the horizontal portion of the first connection bracket 400a, while the top surface of the second undercover 500 can be formed in a plate shape is fixed to the underside of the horizontal portion of the second connection bracket 500a.

The first undercover 400 can be formed to face the rear battery pack 100b while the second undercover 500 can be formed to face the front battery pack 100a such that the end of the second undercover 500 can overlap the end of the first undercover 400.

Thus, the gap (g) formed between the front battery pack 100a and the rear battery pack 100b can be sealed off by the first undercover 400 and the second undercover 500.

Therefore, foreign matters can be prevented or hindered from getting stuck or accumulating between the battery and the chassis frame 800 so that the entry of foreign matters can be prevented or hindered during battery replacement.

Furthermore, according to an embodiment of the present disclosure, the first undercover 400 and the second undercover 500 can overlap in a sloping structure.

Specifically, a first slope 410 can be formed on the underside of the first undercover 400 and a second slope 510 facing the first slope 410 can be formed on the top surface of the second undercover 500 to overlap the first slope.

FIG. 11 shows the first slope 410 sloping upward toward the second undercover 500 can be formed on the underside of the end of the first undercover 400 while the second slope 510 sloping downward toward the first undercover 410 can be formed on the top surface of the end of the second undercover 500.

The first slope 410 and the second slope 510 can be formed with matching slopes such that the first slope 410 and the second slope 510 are in contact with each other so that the contact area between the first undercover 400 and the second undercover 500 increases.

Furthermore, the first undercover 400 and the second undercover 500 can be made of materials having a selected or predetermined elasticity or more so that the first slope 410 and the second slope 510 are in close contact to prevent or hinder the entry of foreign matters more reliably.

Furthermore, according to an embodiment of the present disclosure, another battery pack 100 for which the second undercover 500 is formed may be mounted in the rear of the battery pack 100 for which the first undercover 400 is formed.

FIG. 11 shows that, in consideration of the replacement order of the battery packs 100, the first undercover 400 having a slope on the underside can be fixed to the battery pack 100a mounted in the front among the two battery packs 100a, 100b mounted in the front and rear while the second undercover 500 having a slope on the top surface can be fixed to the battery pack 100b mounted in the rear.

For example, because the rear battery pack 100b can be removed when one of the two battery packs 100a, 100b mounted in the front and rear is to be removed, sloping the top surface of the second undercover 500 fixed to the rear battery pack 100b can allow the downward removal of the rear battery pack 100b. As a result, the replacement of the battery pack 100 can be smoothly carried out.

Furthermore, according to an embodiment of the present disclosure, the width of the overlapping between the first undercover 400 and the second undercover 500 can be equal to the width of the gap (g).

FIG. 11 shows that the front-to-rear length of the overlapping between the first undercover 400 and the second undercover 500 that extends between the front battery pack 100a and the rear battery pack 100b can be equal to the front-to-rear length of the gap (g) formed between the front battery pack 100a and the rear battery pack 100b so that the gap (g) can be tightly sealed off by the first undercover 400 and the second undercover 500 to prevent or hinder entry of foreign matters more reliably.

Furthermore, according to an embodiment of the present disclosure, the bottom of the first undercover 400 and the second undercover 500 may be positioned at the same height as or higher than the bottom surfaces of the battery pack 100 and the other battery pack 100.

FIG. 11 shows that when the battery pack 100 is at the lowest ground clearance of the vehicle, the bottoms of the first undercover 400 and the second undercover 500 can be at the same height as the bottom of the battery pack 100, or the bottoms of the first undercover 400 and the second undercover 500 can be higher than the bottom of the battery pack 100.

Positioning the first undercover 400 or the second undercover 500 lower than the battery pack 100 can further reduce the minimum ground clearance of the vehicle, and the marketability of the vehicle may be adversely affected consequently. Therefore, the position of the bottoms of the first undercover 400 and the second undercover 500 relative to the position of the bottom of the battery pack 100 can be regulated.

In this way, the gap (g) formed between the front and rear battery packs 100a, 100b can be automatically sealed off by the undercover 300 extending from the battery packs.

Therefore, not only can the gap (g) be easily sealed off but also foreign matters can be prevented or hindered from getting stuck or accumulating between the batteries and the chassis frame 800 so that the entry of foreign matters can be prevented or hindered during battery replacement or when a battery is omitted.

On the other hand, only specific embodiments of the present disclosure are described in detail, but those skilled in the art can understand that various modifications and amendments are possible within the scope of the technical spirit of the present disclosure and such modifications and amendments can be within the scope of the appended patent claims.

What is claimed is:

1. An electric vehicle body comprising:
a first battery pack replaceably mounted on a chassis frame;
a second battery pack replaceably mounted on the chassis frame;
a cover bracket extending on one side of the first battery pack; and
an undercover extending on one side of the second battery pack adjacent to the first battery pack and overlapping the cover bracket to seal off a gap between the first battery pack and the second battery pack.

2. The body of claim 1, further comprising:
a hollow insertion tube on the cover bracket; and
an insertion protrusion on the undercover, wherein the insertion protrusion is configured to insert into the insertion tube.

3. The body of claim 2, wherein the insertion tube protrudes from a top surface of the cover bracket, wherein the insertion protrusion protrudes from a top surface of the undercover, and wherein the insertion protrusion is configured to insert into the insertion tube as the undercover overlaps a lower portion of the cover bracket.

4. The body of claim 3, wherein an inner protrusion is on an inner surface of the insertion tube, wherein an outer protrusion is on an outer surface of the insertion protrusion, and wherein the outer protrusion is configured to catch on an upper end of the inner protrusion.

5. The body of claim 2, wherein a transverse member of the chassis frame extends along a right-left direction and an upper end of the insertion protrusion is connected to a lower end of the transverse member.

6. The body of claim 5, wherein a first connection hole is at the lower end of the transverse member, wherein a ring-shaped first elastic structure is fixed to an inner surface of the first connection hole, and wherein the insertion protrusion is configured to insert into the first elastic structure to be engaged therewith.

7. The body of claim 1, wherein an undercover width of the undercover is equal to a gap width of the gap.

8. The body of claim 1, wherein a bottom of the undercover is positioned at a same height as or higher than bottoms of the first battery pack and the second battery pack, relative to a ground surface.

9. The body of claim 1, wherein the second battery pack is mounted more rearward on the chassis frame relative to the first battery pack.

10. An electric vehicle body comprising:
a first battery mounting area in a chassis frame;
a first battery pack replaceably mounted on a chassis frame in the first battery mounting area;
a second battery mounting area in the chassis frame, the second battery mounting area being configured to mount a second battery pack therein; and
an area cover removably mounted on the chassis frame at the second battery mounting area, the area cover being configured to seal off the second battery mounting area while the second battery pack is not occupied in the second battery mounting area.

11. The body of claim 10, further comprising:
a third battery pack replaceably mounted on the chassis frame;
a cover bracket extending on one side of the first battery pack; and
an undercover extending on one side of the third battery pack adjacent to the first battery pack and overlapping the cover bracket to seal off a gap between the first battery pack and the third battery pack.

12. The body of claim 10, further comprising:
a transverse member of the chassis frame extending along a right-left direction; and
a guide pin protruding from a top surface of the area cover, wherein the guide pin engages with the transverse member to be attached thereto.

13. The body of claim 12, further comprising:
a second connection hole in a lower end of the transverse member; and
a ring-shaped second elastic structure affixed to an inner surface of the second connection hole, wherein the guide pin is inserted into the second elastic structure.

14. The body of claim 10, further comprising a dummy connector on a top surface of the area cover, the dummy connection being configured to connect to a vehicle connector.

15. An electric vehicle body comprising:
a first battery pack replaceably mounted on a chassis frame;
a second battery pack replaceably mounted on a chassis frame adjacent to the first battery pack such that a gap is formed between the first battery pack and the second battery pack;
a first undercover extending on one side of the first battery pack toward the second battery pack; and
a second undercover extending on one side of the second battery pack toward the first battery pack, wherein the second undercover overlaps with the first undercover such that the second undercover together with the first undercover seals off the gap.

16. The body of claim 15, wherein the first undercover and the second undercover overlap each other in a sloping structure.

17. The body of claim 16, wherein a first slope is on an underside of the first undercover, wherein a second slope matching the first slope is on a top surface of the second undercover, and wherein the first slope overlaps the second slope.

18. The body of claim 17, wherein the second battery pack is mounted more rearward on the chassis frame relative to the first battery pack.

19. The body of claim 15, wherein an undercover width of the first undercover and the second undercover while being overlapped with each other is equal to a gap width of the gap.

20. The body of claim 15, wherein bottoms of the first undercover and the second undercover are at the same height as or higher than bottom surfaces of the first battery pack and the second battery pack, relative to a ground surface.
